(19) United States
(12) Patent Application Publication
(10) Pub. No.: US 2026/0102301 A1
(43) Pub. Date: Apr. 16, 2026

(54) Hospital Bed with Integrated Movable Toilet System

(71) Applicant: Jedda Queen, Randallstown, MD (US)

(72) Inventor: Jedda Queen, Randallstown, MD (US)

(21) Appl. No.: 19/422,533

(22) Filed: Dec. 17, 2025

Related U.S. Application Data
(63) Continuation of application No. 18/649,349, filed on Apr. 29, 2024.

(51) Int. Cl. A61G 9/00

(52) U.S. Cl. CPC A61G 9/003

(57) ABSTRACT

A hospital bed with an integrated movable toilet system is provided. The system enables waste elimination directly through a mattress opening without requiring patient lifting or transfer. A movable toilet travels along a support track located beneath a uniquely designed mattress with a circular opening. The toilet can be positioned under the patient when needed and retracted for sanitary disposal of waste, reducing patient discomfort, staff burden, and risk of exposure to bodily fluids.

### CROSS REFERENCE TO RELATED APPLICATION

This application claims the benefit of U.S. Nonprovisional application Ser. No. 18/649,349 filed on Apr. 29, 2024. The above identified patent application is herein incorporated by reference in its entirety.

### BACKGROUND OF THE INVENTION

The present invention relates to hospital beds and patient-support systems, particularly those designed for non-weight-bearing, bedridden, or mobility-restricted individuals. It concerns a hospital bed incorporating a movable toilet system operable beneath the patient to improve hygiene, safety, and convenience.

Hospital beds are designed to support individuals who are bedridden, non-weight-bearing, recovering from surgery, or otherwise unable to move independently. These beds often include adjustable sections, side rails, and specialized mattresses intended to promote comfort, reduce pressure sores, and assist caregivers in repositioning patients. Although such beds provide substantial benefits, they fail to offer an integrated means for assisting patients with toileting needs. As a result, individuals who cannot lift or turn themselves must rely on bedpans, diapers, or frequent manual repositioning by caregivers. These methods have become the default approach in hospitals, nursing homes, and assisted living facilities, yet they carry significant drawbacks that negatively affect both patients and healthcare staff.

Bedpans in particular are difficult to use and frequently cause discomfort, skin irritation, and additional pain for patients who are already medically compromised. The process of placing a bedpan beneath a patient often requires rolling or lifting the patient, which can be physically traumatic, especially for those with spinal injuries, severe weakness, fractures, or surgical wounds. For many patients, repeated attempts to properly position the bedpan result in humiliation, lack of privacy, and emotional distress. Even when properly placed, bedpans commonly shift under the patient's weight, leading to spills, contamination, and the need for immediate cleanup. The reliance on diapers presents similar issues, as patients may be forced to lie in urine or feces for extended periods when staff are busy or unavailable, contributing to bed sores, skin breakdown, and infection risk.

Healthcare providers face their own challenges when using traditional toileting methods for bedridden patients. Manual repositioning exposes nurses and caregivers to back strain, musculoskeletal injuries, and accidental contact with bodily fluids. Staff shortages further compound the problem; delays in assistance can cause patients to soil themselves, increasing the frequency of linen changes and raising the risk of hospital-acquired infections. Existing alternatives such as overhead lift systems, external catheter devices, and specialized commode chairs offer partial solutions but still require patient movement, lack integration with the bed structure, or fail to provide a sanitary and self-contained means of waste collection. No currently available system allows a toilet to be brought directly into alignment beneath the patient without lifting, transferring, or manually repositioning the patient.

These longstanding challenges highlight a critical need for an improved toileting solution that is fully integrated into the bed itself. A system that permits waste elimination through an opening in the mattress and into a toilet that can be positioned beneath the patient would eliminate the discomfort of bedpans, reduce the physical burden on staff, and ensure that waste can be removed without disturbing the patient. The ability to extend and retract the toilet along a movable track would allow caregivers to safely dispose of waste while avoiding direct contact with bodily fluids. Such an approach would address the shortcomings of existing devices by providing a sanitary, dignified, and efficient method for toileting bedridden individuals while significantly reducing contamination risk and caregiver workload. The present invention fulfills these unmet needs by offering a hospital bed with an integrated movable toilet system that overcomes the deficiencies inherent in prior solutions.

In light of the devices disclosed in the known art, it is submitted that the present invention substantially diverges in design elements and methods from the known art and consequently it is clear that there is a need in the art for a hospital bed with integrated movable toilet system. In this regard the instant invention substantially fulfills these needs.

### SUMMARY OF THE INVENTION

In view of the foregoing disadvantages inherent in the known types of toileting solutions for bedridden or non-weight-bearing patients, the present invention provides a new hospital bed with an integrated movable toilet system that enables waste elimination without requiring the patient to be lifted, rolled, or transferred. The invention allows a toilet to be selectively positioned beneath a mattress opening and then retracted for sanitary removal, thereby improving patient comfort, reducing caregiver burden, and minimizing exposure to bodily fluids.

It is an objective of the present invention to provide a hospital bed with integrated movable toilet system comprising a mattress with a circular opening, a fitted sheet with a corresponding opening, and a toilet mounted on a movable track positioned under the mattress frame. When needed, the movable toilet is advanced beneath the patient so waste can be eliminated directly downward into the toilet without disturbing the patient. After use, the toilet is retracted along the track for cleaning and disposal of waste.

It is an objective of the present invention to provide a hospital bed with integrated movable toilet system that enables waste elimination without requiring the patient to be lifted, rolled, or manually repositioned. The system incorporates a movable toilet that travels along a track and aligns beneath a mattress opening to receive waste directly. This arrangement reduces physical strain on caregivers and minimizes disruptions to patient comfort and safety. The system thereby facilitates hygienic waste removal in a controlled and predictable manner.

It is an objective of the present invention to provide a hospital bed with integrated movable toilet system that reduces the risk of contamination and exposure to bodily fluids for healthcare personnel. The movable toilet is configured to retract away from the patient for waste disposal, creating a separation between the waste collection process and patient care activities. This reduces the likelihood of accidental spills or contact with hazardous materials.

It is an objective of the present invention to provide a hospital bed with integrated movable toilet system that improves patient hygiene and reduces the occurrence of skin breakdown, irritation, and infection. By enabling immediate elimination into the movable toilet, the system prevents prolonged contact between the patient and bodily waste. This reduces moisture retention and pressure-related irritation at the skin surface. The system thereby supports improved clinical outcomes for immobile or medically fragile patients.

It is an objective of the present invention to provide a hospital bed with integrated movable toilet system that reduces dependency on diapers, bedpans, and frequent linen changes. The direct waste-elimination capability alleviates the need for manual placement of bedpans or routine replacement of absorbent materials. This results in fewer patient transfers and reduced handling of soiled items.

It is an objective of the present invention to provide a hospital bed with integrated movable toilet system that facilitates rapid disposal and cleaning without disturbing the patient. The movable toilet is configured to extend beyond the bed frame, allowing caregivers to empty and sanitize the toilet while the patient remains stationary. This reduces procedure time and minimizes the patient's exposure to odors or discomfort. The system ensures that toileting operations can be completed efficiently and discreetly.

It is therefore an object of the present invention to provide a new and improved hospital bed with integrated movable toilet system that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the hospital bed with the movable toilet positioned beneath the mattress opening.

FIG. 2 shows a perspective view of an embodiment of the movable toilet extended outward along the track for emptying.

FIG. 3 shows a perspective view of an embodiment of the fitted sheet with circular opening aligned with the mattress opening.

### DETAILED DESCRIPTION OF THE INVENTION

Reference is made herein to the attached drawings. Like reference numerals are used throughout the drawings to depict like or similar elements of the apparatus. For the purpose of presenting a brief and clear description of the present invention, the embodiment discussed will be used for providing a hospital bed with an integrated movable toilet system configured to position a toilet beneath a mattress opening for direct waste elimination and to retract the toilet for sanitary removal without requiring patient lifting or repositioning. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment,” “second embodiment,” or “third embodiment” does not necessarily refer to the same embodiment.

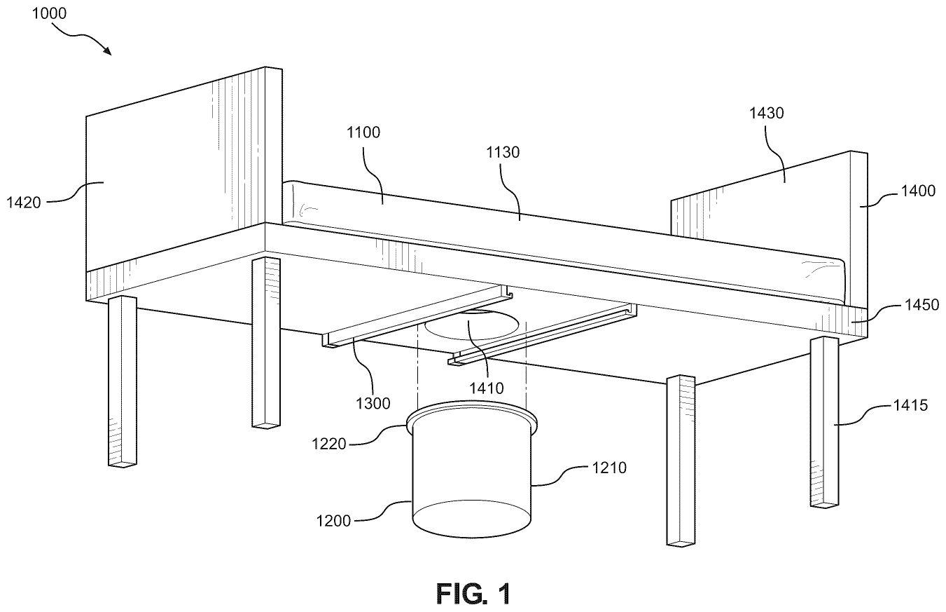

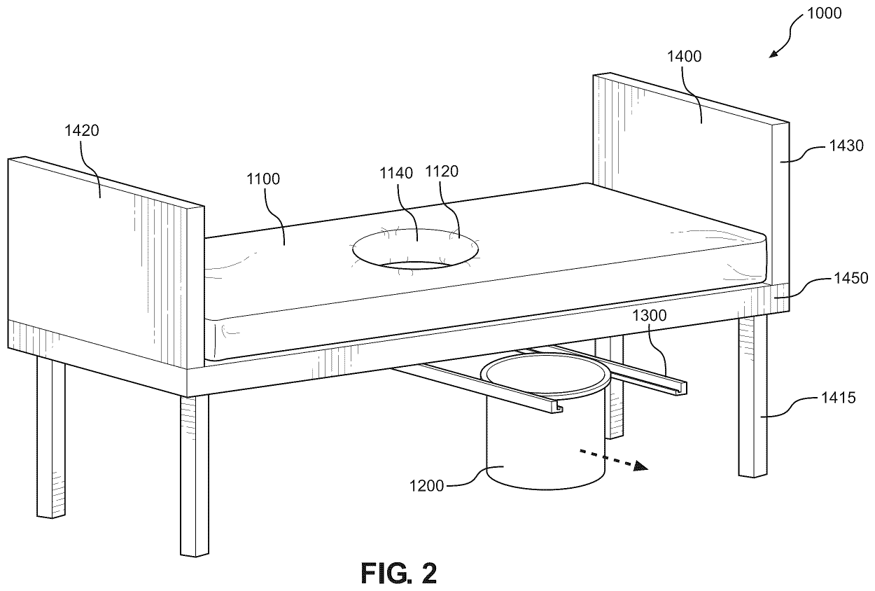

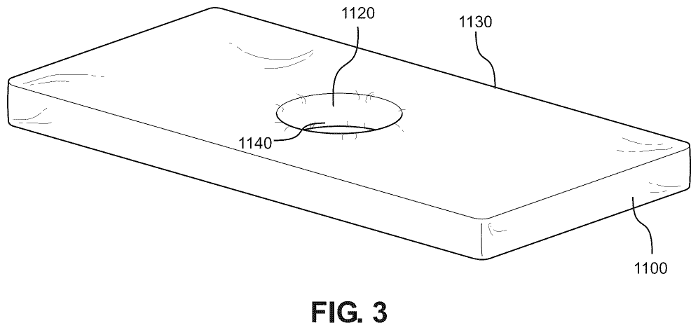

Referring now to FIGS. 1-3, there is shown a perspective view of an embodiment of the hospital bed with the movable toilet positioned beneath the mattress opening, a perspective view of an embodiment of the movable toilet extended outward along the track for emptying, and a perspective view of an embodiment of the fitted sheet with circular opening aligned with the mattress opening, respectively. The hospital bed with integrated movable toilet system 1000 includes a mattress 1100 having a circular opening 1120, a fitted sheet 1130 having a corresponding circular opening 1140, and a toilet 1200 positioned on a movable track 1300 beneath the mattress 1100. In the illustrated embodiment, the movable track 1300 is positioned on an underside of a bed frame 1400 having a corresponding opening 1410 that receives the mattress 1100 thereon. The toilet 1200 is selectively movable between a first position directly beneath the mattress opening and a second position extended outward from the bed frame to allow waste removal and cleaning.

The mattress 1100 may be formed of foam, gel-infused foam, air-cell structures, alternating-pressure bladders, or combinations thereof, provided that the internal structure supports the patient while accommodating an integrated circular opening. The term “circular opening” is used herein to refer to any perimeter shape capable of receiving waste therethrough, including circular, oval, elliptical, polygonal, or generally rounded apertures. The opening extends from the top surface of the mattress to the underside, creating a continuous passage that aligns with the movable toilet when the toilet is positioned beneath the bed. In certain embodiments, a rigid or semi-rigid perimeter ring is embedded within the mattress material surrounding the opening to maintain structural integrity and prevent deformation when weight is applied.

The fitted sheet 1130 is configured to stretch over the mattress 1100 and includes a sheet opening 1140 aligned with the mattress opening 1120. The sheet may be formed of cotton, polyester blends, antimicrobial fabrics, waterproof membranes, or any textile commonly used in medical bedding. The sheet opening 1140 may be reinforced by stitching, a fabric hem, or an elastic boundary to maintain proper alignment with the mattress opening during patient movement or bed adjustments. In one embodiment, the sheet opening 1140 includes a removable cover panel attachable by snaps, hook-and-loop fasteners, zippers, or other fastening means that allow the opening to remain closed when the movable toilet is not in use.

The hospital bed frame 1400 supports the mattress and houses the movable toilet system. In one embodiment, the hospital bed frame 1400 comprises a rectangular support structure formed by mattress support surface 1450 defining a rigid perimeter beneath the mattress. The frame is supported by four legs 1415 positioned at the corners of the perimeter, each leg extending downward to provide stable elevation above the floor surface. The legs may be formed of steel, aluminum, or reinforced composite materials and may optionally include casters, stationary feet, locking mechanisms, or height-adjustable sections. A headboard 1420 is positioned at the proximal end of the frame 1400, while a footboard 1430 is positioned at the distal end, each board being secured to the end rails to provide structural rigidity and patient support. The headboard and footboard may be formed of polymer panels, metal tubing, or laminated wood and may incorporate handholds, attachment interfaces, or protective padding. The bed frame may further include intermediate crossbars or support beams extending between the longitudinal rails to support the mattress platform and the movable toilet track assembly. These structural components maintain the load-bearing capacity of the bed while accommodating the integration of the movable toilet system beneath the mattress. The movable track 1300 is mounted beneath the mattress support surface 1450 and defines a linear or curvilinear path along which the toilet 1200 travels. The term movable track refers to any support mechanism that guides the toilet from one position to another, including rails, linear bearings, telescoping arms, drawer-slide mechanisms, or guided channels.

The toilet 1200 is positioned on the movable track 1300 and includes a waste-receiving container 1210 and a retention interface 1220 configured to engage the track. In the illustrated embodiment, the retention interface 1220 is a lip that extends perpendicularly outward from the upper end of the waste receiving container 1210. The waste-receiving container may be formed of polymer, stainless steel, composite materials, or other sanitary surfaces suitable for cleaning and repeated use. The container 1210 may include a removable liner or an internal cavity for containing waste until disposal. In one embodiment, the toilet is fitted with a sealing lid that automatically closes when the toilet is retracted outward from beneath the mattress opening to reduce odor and prevent spillage.

The movable toilet transitions between configurations by sliding along the track. When the toilet is in the first configuration, it is positioned directly beneath the mattress opening such that the central axis of the toilet bowl aligns with the axis of the opening, allowing waste to fall vertically into the bowl. When the toilet is in the second configuration, it is extended outward from the bed frame so that a caregiver can empty or replace the waste container. The transition between configurations is achieved by manual pulling, powered actuation, or assisted movement mechanisms such as spring-loaded slides or motor-driven rails. The movement may be guided by mechanical stops that define the maximum inward and outward travel limits.

In an alternative embodiment, the movable toilet includes a telescoping support arm that pivots or rotates to position the toilet beneath the mattress opening. A non-exhaustive list of suitable arm mechanisms includes rotary hinges, pivot joints, scissor arms, and articulating brackets. In another embodiment, the toilet is removable from the track, permitting transport to a disposal station without lifting or disturbing the patient.

Another embodiment includes sensors integrated into the bed frame for detecting when the toilet is properly aligned beneath the opening, ensuring that waste is accurately received by the toilet bowl. Such sensors may be optical sensors, magnetic alignment indicators, mechanical position switches, or other position-validation systems. Optional illumination or indicator lights may be used to assist caregivers in confirming correct alignment.

The system may incorporate additional features such as splash guards, odor-control filters, antimicrobial coatings, and sealing gaskets positioned around the mattress opening. These features reduce contamination risk and improve hygiene during operation.

In an exemplary use, a patient is positioned on the mattress such that the circular opening is located beneath the pelvic region. The fitted sheet is stretched over the mattress with the sheet opening aligned with the mattress opening. When toileting is required, a caregiver moves the toilet along the track from the retracted position to the aligned position beneath the opening. Waste is received directly into the toilet bowl without requiring the patient to be lifted or repositioned. Following use, the caregiver retracts the toilet along the track until it extends outward from the bed frame. The waste is then removed, the bowl is cleaned or the liner replaced, and the toilet is returned to the retracted configuration until needed again. Throughout this process, the patient remains stationary on the bed, and the risk of caregiver exposure to bodily fluids is significantly reduced.

The described system provides a controlled, sanitary, and mechanically supported solution for toileting bedridden patients while enabling numerous configurations and embodiments suitable for various clinical environments. Modifications to the structure, materials, or components may be made without departing from the functional intent of providing a movable toilet system integrated into a hospital bed to facilitate direct waste elimination beneath a mattress opening.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A hospital bed with an integrated movable toilet system, comprising:
a bed frame having a mattress support surface;
a mattress positioned on the mattress support surface, the mattress having an opening extending from an upper surface to a lower surface;
a sheet positioned over the mattress, the sheet having a circular opening aligned with the circular opening of the mattress;
a movable track mounted to the bed frame beneath the mattress support surface;
a toilet positioned on the movable track and movable between a first position aligned beneath the opening for receiving waste and a second position extended outward from the bed frame for disposal of waste.

2. The hospital bed of claim 1, wherein the movable track comprises a pair of parallel rails secured to an underside of the bed frame, the rails configured to guide linear movement of the toilet between the first and second positions.

3. The hospital bed of claim 1, wherein the toilet comprises a waste-receiving container having an upper retention interface extending outwardly from an upper rim of the container, the retention interface configured to engage the movable track.

4. The hospital bed of claim 1, wherein the opening of the mattress includes a rigid or semi-rigid perimeter ring embedded within the mattress to maintain structural stability around the opening during patient use.

5. The hospital bed of claim 1, wherein the bed frame comprises four legs positioned at four corners of a rectangular mattress support surface, the legs supporting a headboard at a proximal end and a footboard at a distal end of the frame.

6. The hospital bed of claim 1, wherein the movable track is mounted beneath a mattress support surface comprising one or more crossbars extending between longitudinal frame rails of the bed frame.

7. The hospital bed of claim 1, wherein the sheet comprises a reinforced boundary around the circular opening, the reinforced boundary selected from stitching, elastic material, a hemmed edge, or combinations thereof.

8. The hospital bed of claim 1, wherein the toilet comprises a removable liner positioned within the waste-receiving container to facilitate disposal of waste collected during use.

9. The hospital bed of claim 1, wherein the movable track includes travel-limiting stops configured to define a maximum inward travel position aligned beneath the mattress opening and a maximum outward travel position extending beyond the bed frame.

10. The hospital bed of claim 1, wherein the bed frame further comprises side rails mounted to opposing sides of the frame to prevent patient falls during use.

11. The hospital bed of claim 1, wherein the movable track comprises a drawer-slide mechanism including a stationary rail attached to the bed frame and a movable rail attached to the toilet.

12. The hospital bed of claim 1, wherein the circular opening of the mattress extends fully from an upper mattress surface to a lower mattress surface to form a continuous passageway aligned with the toilet in the first position.

13. The hospital bed of claim 1, wherein the toilet is configured to be removable from the movable track for transport to a disposal or cleaning station.

14. The hospital bed of claim 1, wherein the sheet includes a removable cover panel configured to selectively close the circular opening when the movable toilet is not in use.
